(19) United States
(12) Patent Application Publication
(10) Pub. No.: US 2007/0191171 A1
(43) Pub. Date: Aug. 16, 2007

(54) Differential with die formed housing

(76) Inventors: David Mark Pascoe, Newmarket (CA); David Dorigo, Oakville (CA); Cheng Mu, Toronto (CA); Jianwen Li, Mississauga (CA)

Correspondence Address: CLARK HILL, P.C., 500 WOODWARD AVENUE, SUITE 3500, DETROIT, MI, 48226, US

(21) Appl. No.: 10/570,912

(22) PCT Filed: Sep. 15, 2004
(86) PCT No.: PCT/CA04/01623

§ 371 Date: Jan. 8, 2007

Related U.S. Application Data
(60) Provisional application No. 60/503,009, filed on Sep. 15, 2003.

(51) Int. Cl. F16H 48/06

(52) U.S. Cl. 475/230

(57) ABSTRACT

A differential comprises a die formed housing having a spherical inner volume. A subassembly is disposed in the spherical inner volume of the housing. A die formed cover is fixedly attached to the die formed housing for enclosing the subassembly with the housing. A ring gear is connected to the housing for transmitting torque from a prime mover through the differential. The differential is both light and strong and reasonably inexpensive to manufacture.

### FIELD OF THE INVENTION

The present invention relates to differentials for vehicles. More specifically, the present invention relates to a differential with at least part of its housing being die formed.

### BACKGROUND OF THE INVENTION

Differentials are employed in vehicles to permit the two wheels on an axle to rotate at different velocities when rounding the slightest corner. In rear wheel drive vehicles, the differential is employed at the rear axle and the converse is true in front wheel drive vehicles. Four-wheel drive vehicles employ a differential at each axle; that is, both front and rear.

Differentials are robustly manufactured, as their housings must accommodate high torques and loadings without breaking and without distorting, as the alignment of various components within the differential are critical and require the housing to resist deformations to maintain their alignment. Conventionally, differentials have been made with one-piece cast iron housings and, due to the relative low strength of cast iron; these housings have required relatively thick walls to carry the expected loads. Further exacerbating this problem is the fact that conventional differential housings typically include a pair of large openings on opposing sides of the housing to permit assembly of the differential. These large openings represent a significant potential weakness in the housing, which must be countered by further strengthening the housing by increasing the wall thickness. An increase in the amount of cast iron employed in the housing undesirably increases its weight, volume, and cost.

Previous attempts have been made to provide an improved differential. For example, U.S. Pat. Nos. 6,061,907 and 6,176,152 to Victoria teach the manufacture of a differential housing from steel using a cold flow-forming and/or cold spin-forming process. By employing steel for the housing, rather than cast iron, the required strength of the housing can be obtained with a thinner gauge, lower weight housing.

While the differential housing taught by Victoria is an improvement over conventional differential housings, it still suffers from disadvantages in that cold flow forming and/or cold spin-forming are expensive and time consuming manufacturing processes.

Thus, it is desirable to provide a differential housing of steel or the like and a method of manufacturing the housing, which avoids the problems and/or disadvantages of the prior art.

### SUMMARY OF THE INVENTION

According to one aspect of the present invention, there is provided a differential having a die formed differential housing having a spherical inner volume and a subassembly disposed in the spherical inner volume. The subassembly including at least one pinion shaft, at least one pair of bevel pinions disposed on the at least one pinion shaft and at least one pair of bevel gears linked with the at least one pair of bevel pinions. A die formed housing cover is attached to the die formed differential housing for enclosing the subassembly within the differential housing. A ring gear is connected to the differential housing for transmitting torque from a prime mover.

According to another aspect of the present invention, there is provided a method of manufacturing a differential comprising the steps of: (i) die forming a differential housing from a blank, the differential housing including a spherical inner volume and a hub portion having a bore; (ii) die forming a housing cover from a blank, the housing cover including a hub portion having a bore; (iii) assembling a sub-assembly of a pinion shaft, at least two bevel pinions and at least two complementary bevel gears; (iv) inserting the sub-assembly into the spherical inner volume of the differential housing such that the bore of the housing aligns with an inner splined aperture on one bevel gear to receive a splined portion of an axle; (v) fitting the housing cover to the differential housing to enclose the sub-assembly such that the bore of the housing cover aligns with an inner splined aperture on another bevel gear to receive a splined portion of another axle; (vi) attaching the housing cover to the differential housing; and (vii) connecting a ring gear to the differential housing.

The present invention provides a novel differential and method of a making the differential wherein the differential housing and housing closure are manufactured by die forming to obtain a differential which is both light and strong and reasonably inexpensive to manufacture.

### BRIEF DESCRIPTION OF THE DRAWINGS

Preferred embodiments of the present invention will now be described, by way of example only, with reference to the attached Figures, wherein:

FIG. 1 is a cross-sectional view of a differential in accordance with one embodiment of the present invention;

FIG. 2 is a partially cut-away perspective view of the differential of FIG. 1;

FIGS. 3a, 3b, 3c and 3d shows the stages of a method of die forming a differential housing in accordance with one embodiment of the present invention;

FIG. 4 is an isometric view of the differential housing of FIG. 3d;

FIGS. 5a and 5b show the stages of a method of die forming a differential housing cover in accordance with one embodiment of the present invention;

FIG. 6 is an isometric view of the differential housing cover of FIG. 5b;

FIGS. 7a, 7b, 7c, 7d and 7e show steps to assemble the die formed differential of FIG. 1;

FIG. 8 is a cross-sectional view of the differential of FIG. 1 with different bearings; and

FIG. 9 is a cross-sectional view of the differential of FIG. 1 with a welded ring gear.

### DETAILED DESCRIPTION OF THE INVENTION

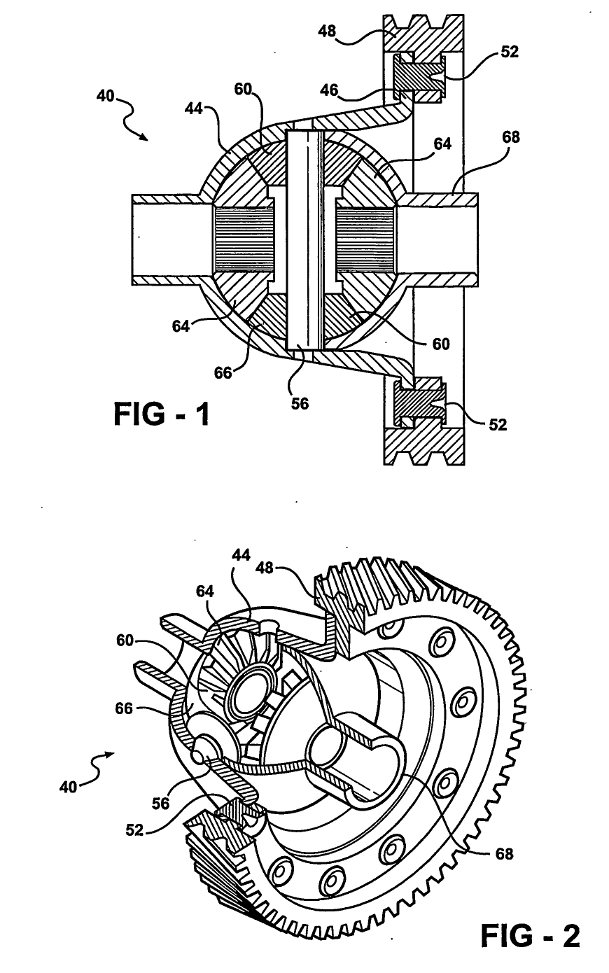

A differential in accordance with one embodiment of the present invention is indicated generally at 40 in FIGS. 1 and 2. In these Figures, and the others of this description, like elements are indicated with like reference numerals.

Differential 40 includes a die formed housing 44, further discussed below, with a flange 46 to which a differential ring gear 48 is attached, in the illustrated embodiment, by rivets 52 although, as will be apparent to those of skill in the art any suitable method of attachment, including bolts, welding, etc. can be employed.

Torque from a transmission or prime mover, not shown, is transferred from ring gear 48 through housing 44 to pinion shaft 56 which, in turn, drives a pair of bevel pinions 60. As will be apparent to those of skill in the art, pinion shaft 56 can ride in suitable bores in housing 44, as will be described in more detail below or pinion shaft 56 can ride in suitable bushings (not shown) which can be provided in bores in housing 44. Bevel pinions 60 engage with complementary bevel gears 64 which are connected to a right and left axle shaft (not shown) respectively which engage, via splines, with a central bore in each respective bevel gear 64. A washer 66 having a complementary shape to the inner surface of housing 44 and to the spherical surfaces of bevel pinions 60 and bevel gears 64 and having a central bore through which pinion shaft 56 passes, is installed between the inner surface of housing 44 and pinions 60 and gears 64.

A housing cover 68, which is also preferably die formed as described below, is attached to housing 44 to close the differential 40 and to provide support for a bearing to carry differential 40 in its casing (not shown). Housing cover 68 can be attached to housing 44 in any suitable manner, as will occur to those of skill in the art, including welding and/or using a fastener.

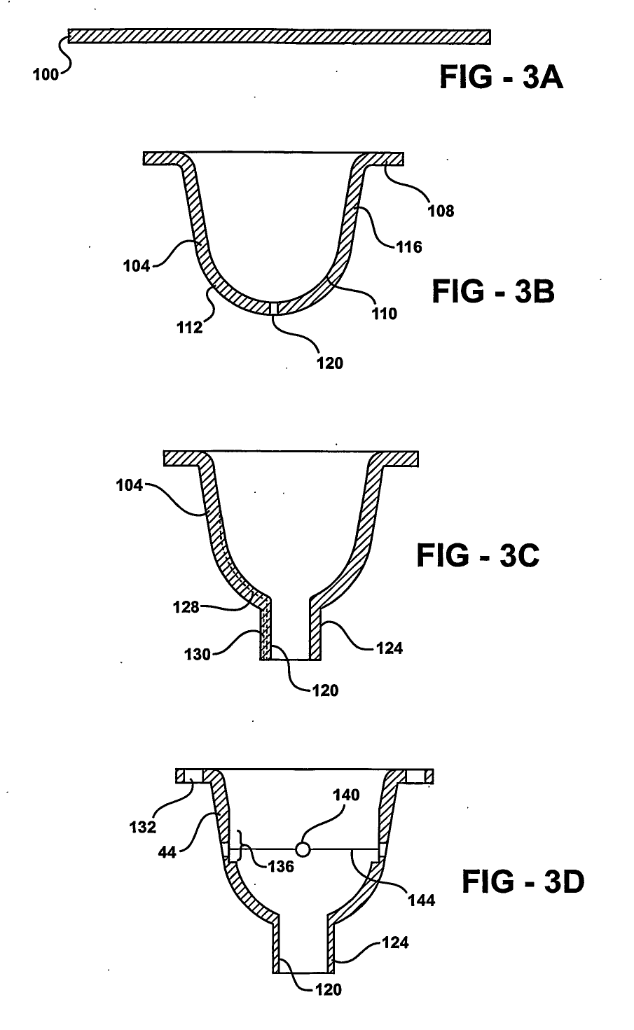

FIGS. 3a, 3b, 3c and 3d show a presently preferred method of die forming a housing 44. A die forming operation as described herein includes contacting a work piece with a pair of punches and dies to shape the work piece in a desired orientation. In a first step, as shown in FIG. 3a, a die blank 100 is provided. The blank 100 is preferably a disc shaped body made from ductile material such as low carbon steel.

In a next step, shown in FIG. 3b, one or more pairs of punches and dies contact the blank 100 to form a generally cup shaped body 104. The cup shaped body 104 may be formed in a single die forming operation, or alternatively using a plurality of die forming operations to form various portions of the cup shaped body 104. The cup shaped body 104 includes a flange 108, a generally conical support portion 116, and a generally spherical inner portion 112 that defines a generally spherical inner volume 110. A small central bore 120 is also formed in the center of spherical portion 112.

In a following step, as shown in FIG. 3c, bore 120 is formed into hub portion 124 through one or more die forming operations and cup shaped body 104 can be machined as indicated by dashed line 128, if necessary, to achieve desired tolerances and clearances. For example, hub portion 124 can be machined to form a journal and shoulder to receive a bearing, as indicated by dashed line 130.

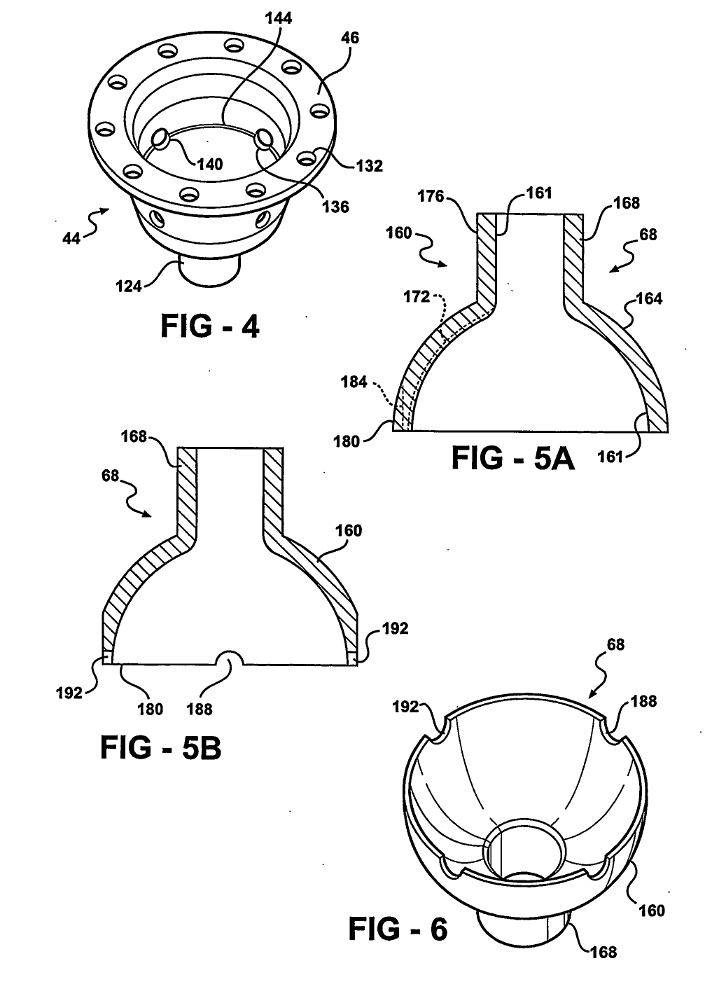

In a final step, as shown in FIGS. 3d and 4, cup shaped body 104 is machined to include: attachment points 132 (if necessary) for ring gear 48, journals and bores 136 for pinion shafts 56, oil lubrication holes 140 and a ledge or surface 144 to which housing cover 68 can be attached.

As will be apparent to those of skill in the art, further processing of differential housing 44 and/or housing cover 68 can be performed if required. For example, heat-treating of housing 44 and/or cover 68 can be performed if desired to further strengthen these components. Also, welds, gussets and other strengthening structures can be added if desired.

FIGS. 5a and 5b illustrate the steps in a preferred method of manufacturing housing cover 68. Similar to the method discussed above for forming housing 44, a disc shaped blank (not shown), preferably made from ductile material such as low carbon steel, is die formed, by die forming operations with one or more punch and die pairs to obtain the cup shaped body 160 shown in FIG. 5a. The cup shaped body 160 includes a spherical inner portion 164 and a hub portion 168. A central bore 161 is also formed in the center of the spherical inner portion 164.

In an optional next machining step, inner portion 164 can be machined, as indicated by dashed line 172 to a required final shape. Additionally, hub portion 168 can be machined to provide a journal and shoulder for a bearing, as indicated by dashed line 176. Also, to provide for connection of the housing cover 68 to housing 44, an edge 180 can be machined to a required tolerance as indicated by dashed line 184.

In a final step of manufacturing the housing cover 68, as shown in FIGS. 5b and 6, two or more oil lubrication holes 188 can be machined into the cup shaped body 160. Additionally, the cup shaped body 160 can be machined forming journals and bores 192 for pinion shaft 56.

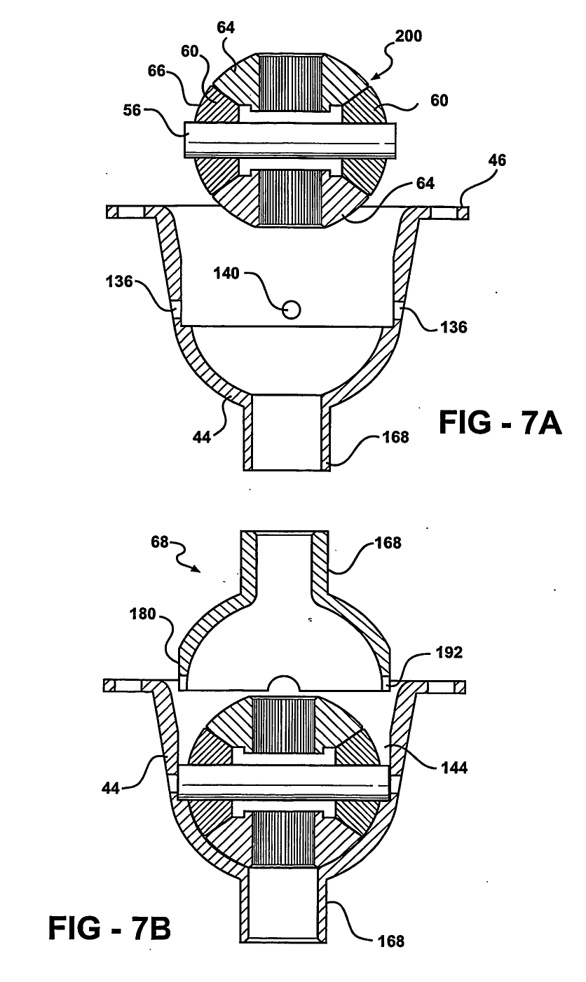

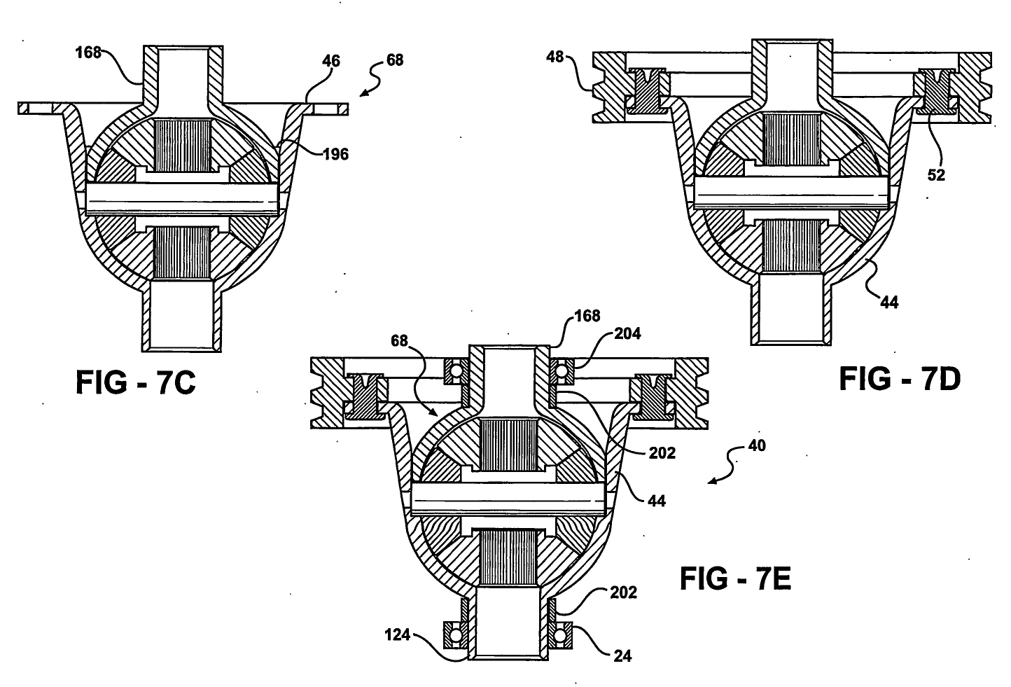

FIGS. 7a through 7e show preferred steps for assembling differential 40. As illustrated in FIG. 7a, a subassembly 200 is first assembled from bevel gears 64, meshed bevel pinions 60, washer 66 and pinion shaft 56, which is inserted, into bevel pinions 60. Subassembly 200 is next installed inside the inner volume 110 of housing 44, with the ends of pinion shaft 56 being received in journals and bores 136 formed in housing 44. The subassembly 200 is installed such that the bore 136 aligns with an inner splined aperture (not shown) formed on one of the bevel gears 64 for receiving a splined portion of an axle (not shown).

Next, as shown in FIG. 7b, housing cover 68 is fitted to housing 44 bringing edge 180 of housing cover 68 into contact with surface 144 while ensuring that journals and bores 192 correctly engage pinion shaft 56. Housing cover 68 is then permanently welded, or otherwise connected, to housing 44 at 196, as best shown in FIG. 7c.

Next, differential ring gear 48 is connected to housing 44 by rivets 52, or another suitable connection means, as shown in FIG. 7d.

Finally, assembly is completed by adding bushings 202 and bearings 204, which can be tapered roller bearings or radial ball bearings or any other suitable bearings, to the hubs 124, 168 of housing 44 and housing cover 68 as illustrated in FIG. 7e. The assembled differential 40 can then be installed in a casing, as required.

As will be apparent to those of skill in the art, depending upon the torque which differential 40 is intended to carry, differential 40 can include three or four pinion shafts 56 and associated pinions 60 to increase the contact area between pinions 60 and bevel gears 64 to better carry the torque.

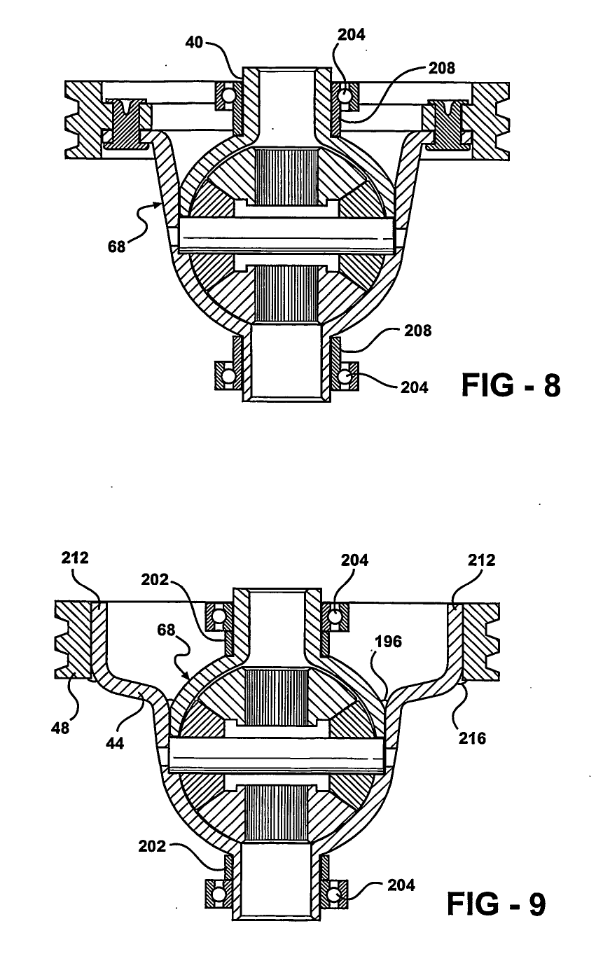

FIG. 8 shows an alternative embodiment of differential 40, wherein bearings 204 include a long inner race 208, thus eliminating the need for bushings 202.

FIG. 9 shows another alternative embodiment of differential 40, wherein ring gear 48 is connected to housing 44 by welding, rather than by rivets or screws. As illustrated, housing 44 is slightly modified in shape relative to the above-described embodiment wherein the laterally extending flange 46 is removed and, a cylindrical flange 212 is provided to which ring gear 48 is welded via a bead 216 of weld.

The die forming of differential housing 44 and housing cover 68 provides several advantages over the prior art. The above-mentioned disadvantages with respect to the size and weight of cast iron housings are avoided. Further, die forming is a relatively fast process, compared to cold flow-forming and/or cold spin-forming and is less expensive to employ. Further, the die forming process better supports flexible manufacturing techniques. A manufacturing line established to manufacture the housing and housing cover for one differential could easily and quickly have its pairs of dies and punches changed to manufacture other differentials.

The above-described embodiments of the invention are intended to be examples of the present invention and alterations and modifications may be effected thereto, by those of skill in the art, without departing from the scope of the invention which is defined solely by the claims appended hereto.

What is claimed is:

1. A differential (40) comprising:
a die formed differential housing (44) having a spherical inner volume (110);
a subassembly (200) disposed in the spherical inner volume (110), the subassembly (200) including at least one pinion shaft (56), at least one pair of bevel pinions (60) disposed on the at least one pinion shaft (56) and at least one pair of bevel gears (64) linked with the at least one pair of bevel pinions (60);
a die formed housing cover (68) attached to the die formed differential housing (44) for enclosing the subassembly (200) within the differential housing (44); and
a ring gear (48) connected to the differential housing (44) for transmitting torque from a prime mover.

2. The differential of claim 1 wherein the housing (44) includes a cup-shaped body (104) defining the spherical inner volume (110) and a hub portion (124) extending from the cup-shaped body (104) for receiving an axle.

3. The differential of claim 2 wherein the differential housing (44) includes a laterally extending flange (46) for connecting the ring gear (48) to the differential housing (44).

4. The differential of claim 2 including a cylindrical flange (112) formed on the differential housing (44) for connecting the ring gear (48) to the differential housing (44).

5. The differential of claim 2 wherein the cup-shaped body (104) includes a spherical inner portion (112) and a conical support portion (116).

6. The differential of claim 5 wherein the housing (44) includes a ledge (144) formed on the conical support portion (116) of the housing (44) for mating with the housing cover (68).

7. The differential of claim 6 including journals and bores (136) formed in the differential housing (44) for receiving the pinion shaft (56).

8. The differential of claim 7 including oil lubrication holes (140) formed in the differential housing (44).

9. The differential of claim 2 wherein the subassembly (200) includes a washer (66) having a complementary shape to the differential housing (44) disposed between the bevel pinions (60) and bevel gears (64) and the differential housing (44).

10. The differential of claim 2 wherein the housing cover (68) includes a cup-shaped body (160) and a hub portion (168) extending from the cup-shaped body (160) opposite the hub portion (124) of the housing (44) for receiving an axle.

11. The differential of claim 10 wherein the housing cover (68) includes a spherical inner portion (164) and an edge (184) formed thereon for contacting and mating with the ledge (144) on the differential housing (44).

12. The differential of claim 11 including journals and bores (192) formed in the housing cover (68) for receiving the pinion shaft (56).

13. The differential of claim 12 including oil lubrication holes (188) formed in the housing cover (68).

14. A method of manufacturing a differential (40) comprising the steps of:
die forming a differential housing (44) from a blank (100), the differential housing (44) including a spherical inner volume (110) and a hub portion (124) having a bore (120);
die forming a housing cover (68) from a blank, the housing cover (68) including a hub portion (168) having a bore (161);
assembling a sub-assembly (200) of at least one pinion shaft (56), at least two bevel pinions (60) and at least two complementary bevel gears (64);
inserting the sub-assembly (200) into the spherical inner volume (110) of the differential housing (44) such that the bore (136) of the housing (44) aligns with an inner splined aperture on one bevel gear (64) to receive a splined portion of an axle;
fitting the housing cover (68) to the differential housing (44) to enclose the sub-assembly (200) such that the bore (192) of the housing cover (68) aligns with an inner splined aperture on another bevel gear (64) to receive a splined portion of another axle;
attaching the housing cover (68) to the differential housing (44); and
connecting a ring gear (48) to the differential housing (44).

15. The method of manufacturing a differential of claim 14 wherein the ring gear (48) is connected to the differential housing (44) by rivets (52).

16. The method of manufacturing a differential of claim 14 wherein the ring gear (48) is connected to the differential housing (44) by welding via a weld bead (216).

17. The method of manufacturing a differential of claim 14 wherein the die forming step for the differential housing (44) includes a plurality of die forming operations.

18. The method of manufacturing a differential of claim 15 wherein the plurality of die forming operations includes:
providing a ductile disk shaped blank (100);
die forming the blank (100) to form a cup shaped body (104) having a flange (46, 212), a conical portion (116), spherical inner portion (112), and a small central bore (120);
die forming the cup shaped body (104) forming a hub portion (124);
machining the hub portion (124) forming a journal and shoulder (130);
machining the cup shaped body (104) forming attachment points (132) for the ring gear (48);
machining the cup shaped body (104) forming bores (136) for the pinion shafts (56);
machining the cup shaped body (104) forming oil lubrication holes (140);
machining the cup shaped body (104) forming a ledge (114) for attaching to the housing cover (68).

19. The method of manufacturing a differential of claim 14 wherein the die forming step for the differential housing cover (68) includes a plurality of die forming operations.

20. The method of manufacturing a differential of claim 17 wherein the plurality of die forming operations includes:
providing a ductile disk shaped blank;
die forming the blank to form a cup shaped body (160) having a spherical inner portion (164), and a hub portion (168);
machining the inner portion (164) to a desired shape (172);
machining the hub portion (168) forming a journal and shoulder (176);
machining the cup shaped body (160) forming an edge (184) for contacting the differential housing (44);
machining the cup shaped body (160) forming oil lubrication holes (188);
machining the cup shaped body (160) forming journals and bores (192) for receiving the pinion shaft.

21. The method of manufacturing a differential of claim 14 including the step of installing bushings (202) and bearings (204) to the hubs (124, 168) of the differential housing (44) and housing cover (68).

22. The method of manufacturing a differential of claim 14 including the step of heat treating the differential housing (44) and housing cover (68).
